(19) United States
(12) Patent Application Publication
(10) Pub. No.: US 2006/0003057 A1
(43) Pub. Date: Jan. 5, 2006

(54) Gas-release packet with frangible sub-packet

(76) Inventors: Robert Charles Kelly, Houston, TX (US); Drayton Miller, Mobile, AL (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/167,063

(22) Filed: Jun. 24, 2005

Related U.S. Application Data
(63) Continuation-in-part of application No. 10/277,038, filed on Oct. 21, 2002, now abandoned.

(51) Int. Cl. A01N 3/02

(52) U.S. Cl. 426/118

(57) ABSTRACT

Disclosed is a gas-release packet, comprising a flexible gas-permeable material enclosing or comprising one or more liquid-filled frangible sub-packets and a gas-producing chemical composition that is activated when in contact with said liquid.

### CROSS-REFERENCE TO RELATED APPLICATION

This application is a continuation-in-part of application Ser. No. 10/277,038 filed Oct. 21, 2002, the content of which are herein incorporated by reference in their entirety.

### FIELD OF THE INVENTION

This invention relates to packaging that releases gases through gas-permeable surfaces.

### BACKGROUND OF THE INVENTION

It is known in the art to expose biological materials to various chemicals, usually in the gas phase, to preserve them. Chemicals used to provide beneficial results by release of a gas are normally applied by exposure in open containers, which has the disadvantages of accidental spillage and contamination.

There are a number of dry chemicals that, when brought in contact with a liquid, release a gas to desirable effect.

U.S. Pat. No. 6,017,849, entitled Synthesis Methods, Complexes and Delivery Methods for the Safe and Convenient Storage, Transport and Application of Compounds for Inhibiting Ethylene Responses in Plants, issued Jan. 25, 2000, to Daly, et al., discloses methods for inhibiting the ethylene response in plants or plant products, and has three embodiments. The first embodiment relates to methods of minimizing impurities capable of reversibly binding to plant ethylene receptor sites during the synthesis of cyclopropene and its derivatives such as methylcyclopropene, thereby avoiding the negative effects these impurities have on plants treated with cyclopropene and its derivatives. The second embodiment relates to complexes formed from molecular encapsulation agents such as cyclodextrin, and cyclopropene and its derivatives such as methylcyclopropene, in addition to cyclopentadiene and diazocyclopentadiene and their derivatives, thereby providing a convenient means for storing and transporting these compounds capable of inhibiting the ethylene response in plants, which are reactive gases and highly unstable because of oxidation and other potential reactions. The third embodiment relates to convenient methods of delivering to plants these compounds capable of inhibiting the ethylene response in the plants in order to extend their shelf life. These methods involve contacting the molecular encapsulation agent complex with a liquid solvent capable of dissolving it, thereby liberating the compound.

U.S. Pat. No. 6,194,350, entitled Methods of Blocking Ethylene Response in Plants Using Cyclopropene Derivatives, issued Feb. 27, 2001, to Sisler, E. C., discloses methods of applying C.sub-6-20 alkyl cyclopropene derivatives and compositions thereof to block ethylene receptors in plants are disclosed. One such method comprises applying to the plant an effective ethylene response-inhibiting amount of cyclopropene derivatives or compositions thereof. Also disclosed are methods of inhibiting abscission in plants and methods of prolonging the life of cut flowers.

U.S. Pat. No. 5,650,446, entitled Sustained Release Biocidal Composition, issued Jul. 22, 1997, to Wellinghoff, et al., discloses a composite for retarding bacterial, fungal, and viral contamination and mold growth that includes a hydrophobic material comprising an acid-releasing agent and a hydrophilic material containing chlorite anions. The hydrophobic and hydrophilic materials are held adjacent and substantially anhydrous. When exposed to moisture, the hydrophilic material releases chlorine dioxide upon hydrolysis of the acid-releasing agent.

U.S. Pat. No. 6,697,696 discloses apparatus for delivery of a gas, e.g., carbon dioxide and/or chlorine dioxide, and methods of its use and manufacture. The apparatus includes an envelope, and a sachet within the envelope that contains reactant, which generates a gas in the presence of an initiating agent, e.g., water. The envelope allows release of the gas from the envelope. In another embodiment, the apparatus includes an envelope and a partition that separates two reactants within the envelope. The envelope allows an initiating agent into the envelope and release of the gas generated by the reactants in the presence of the initiating agent.

Prior art methods of delivery of these technologies has been the use of open containers into which the chemicals are poured, followed by a gas-releasing solvent. This method has the drawback of dispensing too much or too little of either component and is vulnerable to spillage and contamination.

### SUMMARY OF THE INVENTION

Disclosed is a gas-release packet, comprising a flexible gas-permeable material enclosing one or more liquid-filled frangible sub-packets and a gas-producing chemical composition that is activated when in contact with said liquid.

The most important embodiment of the gas-release packet comprises a flexible gas-permeable material defining a first and second separate compartments divided by a frangible seal, the first compartment containing a liquid, the second compartment containing a gas-producing chemical composition in powder or granular form that is activated when in contact with said liquid. In the most preferred form, the compartment containing the gas-producing chemical composition, is micro-perforated with tiny holes, smaller than the particle size of the gas-producing chemical composition in order to control the rate of exhaust of the generated gas, CO₂ or chlorine dioxide. The perforations are from about 2 microns in diameter to about 50 microns in diameter. Generally speaking, a 20 to 40 micron range is the most ideal size for many different applications of the present invention.

Another embodiment of the gas-release packet comprises a flexible gas-permeable material enclosing two or more liquid-filled frangible sub-packets; at least one of said sub-packets containing a gas-producing chemical composition in liquid form that is activated when in contact with the contents of at least one of said remaining sub-packets.

Another embodiment of the gas-release packet comprises a semi-rigid container the top of which is sealed by a flexible gas-permeable material and into which one or more frangible liquid-filled sub-packet has been placed along with a gas-producing chemical composition that is activated by contact with said liquid.

Another embodiment of the gas-release packet comprises a semi-rigid container the top of which is sealed by a flexible gas-permeable material and into which two or more frangible liquid-filled sub-packets have been placed, at least one of which contains a liquid gas-producing chemical composition that is activated by contact with the liquid from at least one of said other sub-packets.

In another aspect of the invention, the packet is a pillow style bag.

In another aspect of the invention, the packet is a three-side seal style bag.

In another aspect of the invention, the packet is a four-side seal style bag.

In another aspect of the invention, the packet is a side-gusseted square bottom style bag.

In another aspect of the invention, the packet is a bottom-gusseted stand up style bag.

In another aspect of the invention, said gas-producing chemical composition is a cyclopropene or derivative thereof.

In another aspect of the invention, said gas-producing chemical composition produces carbon dioxide gas.

In another aspect of the invention, said gas-producing chemical composition produces a biocidal gas.

In another aspect of the invention, said gas-permeable material comprises polyethylene homopolymer or copolymer and at least one material selected from the group polyamide, copolyamide, polyester, copolyester, polyethylene copolymer, polypropylene homopolymer or copolymer, polycarbonate, polymethylpentene, polyvinylidene chloride copolymer, polyurethane, polybutylene homopolymer or copolymer, and polysulfone.

### BRIEF DESCRIPTION OF THE DRAWINGS

FIG. 1 is a top view of an embodiment of the invention.

FIG. 2 is a top plan view of the most important embodiment of the invention showing a package divided into two separate compartments with a frangible seal or membrane separating the two compartments.

FIG. 3 is a perspective view of yet another embodiment of the invention.

FIGS. 4a through 4c show a pillow style, a fourside seal style, and a three-side seal style embodiment of the invention, respectively.

FIGS. 5a and 5b show a side-gusseted and a bottom-gusseted embodiment of the invention, respectively.

### DETAILED DESCRIPTION OF THE PREFERRED EMBODIMENTS

The packaging of the invention is formed of a gas-permeable material inside of which is sealed a gas-producing chemical composition and a frangible liquid-filled sub-packet. When the sub-packet is broken, the liquid therein is released to react with the chemical and release gas, which passes through the gas-permeable sides of the packet. The packet is for placement within sealed containers with plants or foodstuffs so as to release beneficial gases.

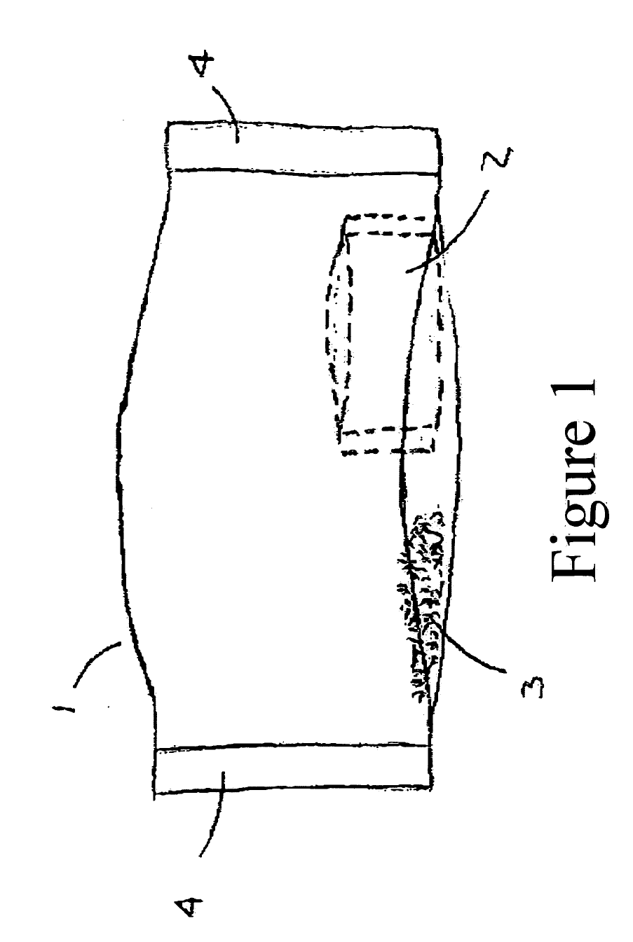

Referring to FIG. 1 there is shown an embodiment of the gas-permeable packet 1 of the invention which contains one or more frangible sub-packets 2 and a gas-producing chemical composition 3. The gas-producing chemical composition 3 need not be a dry chemical as shown, but may also be a liquid and may even be encapsulated in another frangible sub-packet if desired. The packet may be heat-sealed or adhesively bonded along one or more edges, forming seals 4.

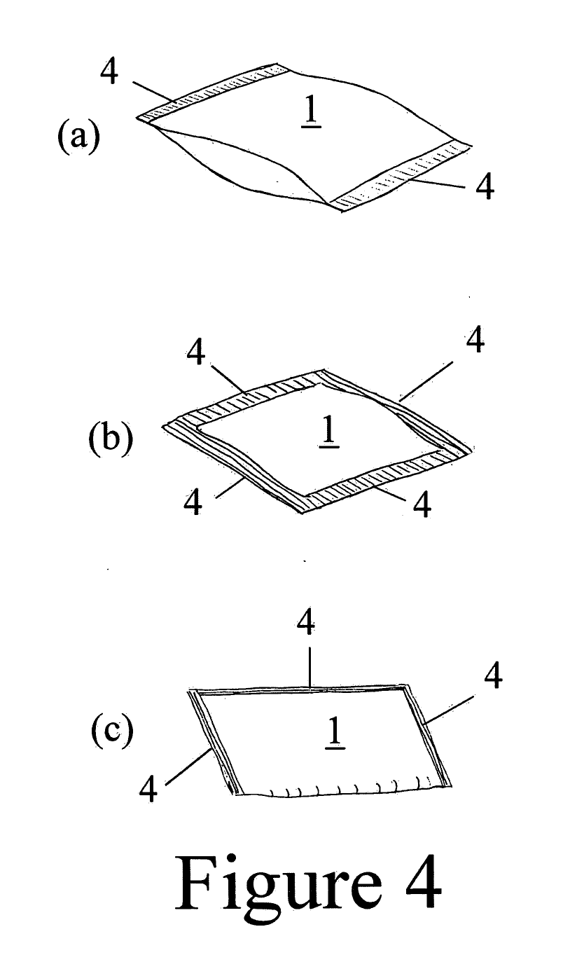

There are a number of convenient ways to manufacture the packet 1. A tube of gas-permeable material may be flattened and sealed at the two open ends, forming the pillow shaped container as shown in FIGS. 1 and 4a . Alternatively, a single sheet of gas-permeable material may be folded over and sealed on three sides as shown in FIG. 4c . Alternatively, two sheets of gas-permeable material may be sealed together on four sides as shown in FIG. 4b.

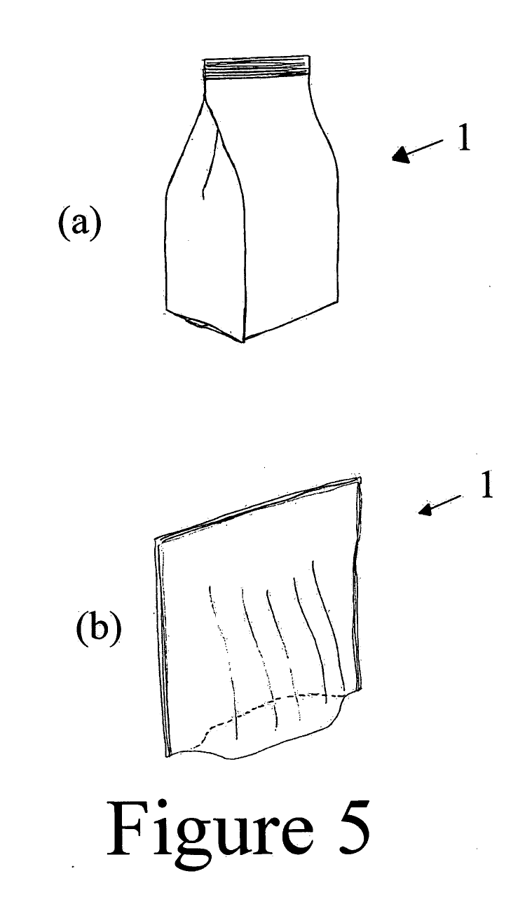

Referring to FIG. 5, the shape of the packet may be gussetted, such as side-gusseted as shown in FIG. 5a , or bottom-gusseted as shown in FIG. 5b . Gussetting removes stress points on the packet and also serves to increase the surface area through which the gas may escape.

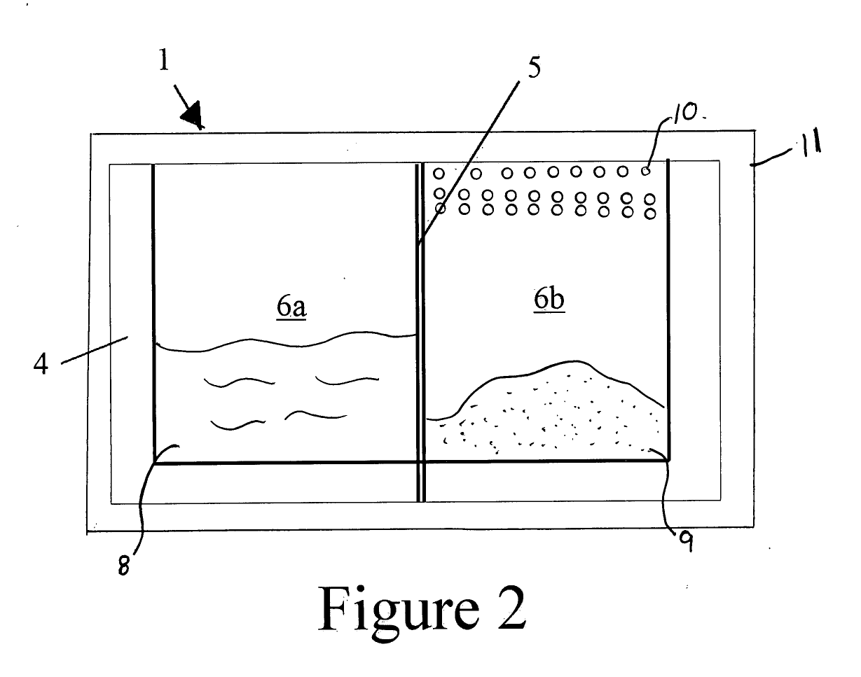

Referring to FIG. 2, the most important embodiment, rather than having a separate frangible sub-packet, the gas-permeable packet 1 is provided with one or more frangible membranes or seals 5 to divide the interior into two or more compartments 6. Two compartments are shown 6a and 6b . In compartment 6a is contained a liquid 8, such as water, e.g. and in compartment 6b is contained a gas generating chemical composition 9 in powder or granular form. The second compartment 6b holding the gas generating chemical composition 9 is perforated with holes (perforations) 10 from about 2 microns in diameter to about 50 microns in diameter. Generally speaking, a 20 to 40 micron range is the most ideal size for many different applications of the present invention. What is important is that the size of the perforations 10 are smaller than the particle size of the powder or granulations of the gas generating chemical composition 9.

For example, in the most important embodiment of FIG. 2, a weak dividing seal or seals may serve this purpose, these dividing seals 5 being weak enough that they will break before the packet seals 4 upon application of pressure upon the gas-permeable packet 1, such as striking the packet with the hand. For example, a weak line of adhesive may be run down the center of the packet, the chemicals injected into each compartment 6, and the packet 1 then heat-sealed to seal off each compartment. Upon squeezing the packet, the weak adhesive will then break rather than the heat seals.

The gas permeable package 1 may be provided with a first compartment 6a and a second compartment 6b , where the frangible membrane or seal 5 divides the interior of the first and second compartments 6a and 6b . The first compartment 6a can be a liquid tight compartment including a liquid 8 therein and the second compartment 6b can include a gas-producing chemical composition 9. The frangible membrane or seal 5 prevents the entry of the liquid 8 from the first compartment 6a into the second compartment 6b . When the frangible membrane or seal 5 is broken, the liquid 8 from the first compartment 6a is released into the second compartment 6b to react with the gas-producing chemical composition 9 and releasing a gas. The gas is released at a control rate from the package 1 through perforations 10 in the second compartment 6b.

As previously noted, the perforations 10 can be between about 2-50 microns in size, wherein the perforations 10 are sized to be less than the particle size of the gas-producing chemical composition 9. Additionally, the size of the perforations 10 may be selected to be less than the size of a water molecule, thus resisting, preventing, or retarding the entry of water molecules into the second compartment 6b through the perforations 10.

The perforations 10 are provided in a spaced apart arrangement on the second compartment 6b , where there is at least about one perforation 10 per every 25 mm. The perforations 10 can be spaced between about 1-10 mm apart and in an embodiment between 1-5 mm apart. The size and quantity of perforations 10 are selected to give the desired controlled release rate under the circumstances of the application of the packet 1, i.e. the use to which it is being put.

The gas permeable package 1 can further be provided in a sealed package 11 for storage, for an increased shelf life. The sealed package 11 can be made from a water or vapor impermeable material, thus substantially preventing the propagation of water or vapor into the sealed package 11. This will assist in maintaining the gas generating chemical composition 9 in a substantially dry condition.

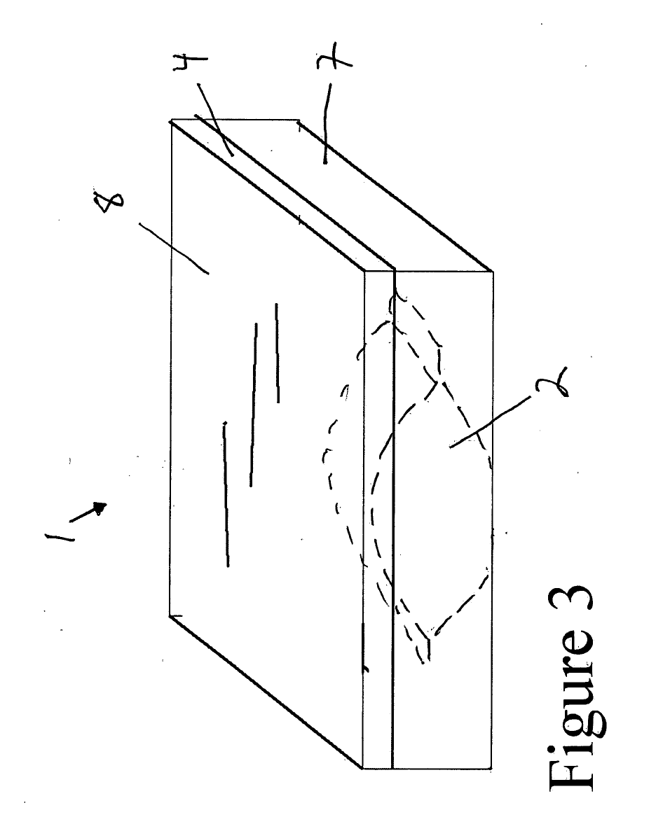

Referring to FIG. 3, in still another embodiment of the invention, a gas-permeable membrane 8 is sealed to a container 7. Preferably, the container will be of a semi-rigid material to facilitate squeezing, so as to rupture the frangible sub-packet 2 within. The container 7 may be in the nature of a tray, cup or any other suitable configuration.

The materials used for the packet of the invention will present as a solid surface, yet be permeable to gas while impermeable to liquid. Liquid-impermeable gas-permeable materials suited for use with the invention include laminations of polyethylene polymer with one or more other materials. Other materials suited for use as a laminate with polyethylene include polyamides, copolyamides, polyester, copolyesters, polyethylene copolymers, polypropylene homopolymers or copolymers, polycarbonate, polymethylpentene, polyvinylidene chloride copolymer, polyurethane, polybutylene homopolymer or copolymer, polysulfone and paper. Coextrusions of these materials with polyethylene may also be used to create clear or opaque gas-permeable materials.

Specific conditions of use for the gas-permeable packet of the invention determine the suitability of a packet material. Metallocene-modified polyethylene (mLLDPE) is desirable as a sealant layer as its high molecular weight promotes gas transmission. Metallocene-modified polyethylene (mLLDPE) can be used solely as the packet material, but to seal mLLDPE to make a packet, it must be heated and then cooled before release from sealing platens. This process is slow and therefore may not be practical for mass production. More desirable is the addition of one or more additional support layers with melting temperatures higher than the sealant layer to support the sealant layer when it is in the molten state. Paper is a desirable outer layer as it has high gas and water vapor transmission rates and provides stiffness to the packet material. Polyethylenes including low density (LDPE), linear low density (LLDPE), and mLLDPE have very low water vapor transmission rates and are useful as an outer layer where the gas-producing chemical composition is water activated, so as to prevent premature activation from ambient water vapor.

Other suitable support layers are cellulose, polystyrene and polyurethane due to their high gas transmission rates, though it must be noted that these materials have high water vapor transmission rates.

As indicated, the gas-producing chemical compositions may be any such chemical compositions suitable to the purpose, such as cyclopropenes and their derivatives as are disclosed in Daly, et al., U.S. Pat. No. 6,017,849; chlorine dioxide releasing compositions, such as disclosed in Wellinghoff et al., U.S. Pat. No. 5,650,466; C₆₋₂₀ alkyl cyclopropene derivatives, such as are described in Sisler, U.S. Pat. No. 6,194,350; the disclosures of all of which are incorporated by reference herein in their entirety. A commercially available cyclopropene derivative is 1-methylcyclopropene, sold under the tradename EthylBloc by Rohm & Haas.

Also suitable as gas-producing chemical compositions are salts of manganese (II), iron (II), cobalt (II), or nickel (II) combined with an alkali and sulfite or a deliquescent substance and optionally ascorbic acid or its salt, which absorb oxygen and/or release carbon dioxide, thereby also effecting a corrosion-inhibiting atmosphere in addition to being beneficial to foodstuffs, such as is disclosed in Nakamura et al., U.S. Pat. No. 4,384,972; carbon dioxide releasing compositions such as disclosed in Leon et al., U.S. Pat. No. 4,664,922; antibacterial releasing compositions such as are disclosed in Breuer et al., U.S. Pat. No. 4,762,922; carbon dioxide generating compositions such as are described in Koyakumaru et al., U.S. Pat. No. 5,489,399; and compositions of organic acid and hydrogencarbonates such as are disclosed in Iijima, U.S. Pat. No. 6,340,654; the disclosures of all of which are incorporated by reference herein in their entirety.

Also useful are other water-activated carbon dioxide-releasing compositions such as sodium bicarbonate, acetylsalicylic acid, and mixtures thereof, known to benefit live plants and prolong shelf life of many perishables, such as is described in Fuller, P. E., Published U.S. patent application Ser. No. 09/771,334, entitled Treatment of Perishable Products Using Aqueous Chemical Composition, filed Jan. 26, 2001, the disclosures of which are incorporated by reference herein in their entirety. Also known are compositions that release both carbon dioxide and sulfur dioxide, a gas mixture useful for preserving grapes, such as citric or tartaric acid, sodium bicarbonate, and sodium or potassium bisulphate as described in Cimino et al., U.S. Pat. No. 4,411,918, the disclosures of which are incorporated by reference herein in their entirety.

Note that gas-absorbing compositions may also be used such as to offer control of the environment in which the packet is placed. For example, such a packet could be placed in metal containers as a means of inhibiting corrosion. This may be achieved by placing in the packet a composition that releases a corrosion inhibiting gas and another composition that absorbs water vapor and/or oxygen, thereby removing the corroding water vapor from the container, such as by combining the composition of Nakamura, supra, with a desiccant. Should the gas-releasing and gas-absorbing compositions be incompatible, the packet may be divided into compartments with, for example, a heat seal, so as to separate the compositions. Alternatively, each composition may be individually sealed in its own packet and the user need only place one of each type into the container.

While various values, scalar and otherwise, may be disclosed herein, it is to be understood that these are not exact values, but rather to be interpreted as “about” such values, Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims.

What is claimed is:

1. A gas-release packet, comprising:
a flexible gas-permeable material defining first and second separate compartments divided by a frangible seal;
the first compartment containing a liquid; and
the second compartment including perforations thereon and containing a gas-producing chemical composition that is activated when in contact with said liquid.

2. The packet as set forth in claim 1 where the perforations are sized to be less than a particle size of the gas-producing chemical composition.

3. The packet as set forth in claim 1 where the perforations are sized to be less than a size of a water molecule.

4. The packet as set forth in claim 1 wherein the perforations are between about 2 and 50 microns in size.

5. The packet as set forth in claim 1 wherein the perforations control the release rate of a gas released when the gas-producing chemical composition is activated.

6. The packet as set forth in claim 1 further comprising a sealed package enclosing the gas-release packet.

7. The packet as set forth in claim 7 wherein the sealed package is made of a water or vapor impermeable material.

8. The packet as set forth in claim 1 wherein the frangible seal includes an adhesive running down a center portion of the packet.

9. The packet as set forth in claim 1 wherein the packet is selected from a pillow style bag, a four-side seal style bag, or a three-side seal style bag.

10. The packet as set forth in claim 1 wherein the packet is gusseted.

11. The packet as set forth in claim 1 wherein said gas-producing chemical composition is a cyclopropene or derivative thereof.

12. The packet as set forth in claim 1 wherein said gas-producing chemical composition produces carbon dioxide gas.

13. The packet as set forth in claim 1 wherein said gas-producing chemical composition produces a biocidal gas.

14. The packet as set forth in claim 1 wherein said gas-permeable material comprises:
polyethylene homopolymer or copolymer; and
at least one material selected from the group polyamide, copolyamide, polyester, copolyester, polyethylene copolymer, polypropylene homopolymer or copolymer, polycarbonate, polymethylpentene, polyvinylidene chloride copolymer, polyurethane, polybutylene homopolymer or copolymer, polysulfone and paper.
